(19) United States
(12) Patent Application Publication
(10) Pub. No.: US 2016/0328808 A1
(43) Pub. Date: Nov. 10, 2016

(54) DATA AGGREGATION AND ANALYTICS FOR DIGITAL MANUFACTURING

(71) Applicant: KEMEERA INC. DBA FATHOM, Oakland, CA (US)

(72) Inventors: Karl Darcy Daniel Willis, Millbrae, CA (US); Wesley Hoke Smith, San Francisco, CA (US)

(21) Appl. No.: 15/149,072

(22) Filed: May 6, 2016

Related U.S. Application Data
(60) Provisional application No. 62/157,553, filed on May 6, 2015.

(51) Int. Cl. G06Q 50/04; G06F 17/30; G06Q 10/06

(52) U.S. Cl. CPC G06Q 50/04; G06Q 10/06395; G06F 17/30867

(57) ABSTRACT

Systems and methods for aggregating and analyzing digital manufacturing data are disclosed. An aggregator can collect output data generated a number of digital manufacturing machines. The output data can be filtered and transmitted to a server for storage in a database. One or more clients can access the data in the database via an API.

### CROSS-REFERENCE TO RELATED APPLICATIONS

This application claims the benefit of U.S. Provisional Patent Application Ser. No. 62/157,553, entitled “DATA AGGREGATION AND ANALYTICS FOR DIGITAL MANUFACTURING,” filed May 6, 2015, the disclosure of which is incorporated by reference herein in its entirety.

### BACKGROUND OF THE INVENTION

This specification relates generally to data aggregation and analytics for digital manufacturing. Data aggregation involves gathering, processing, and filtering data from multiple sources so that it can be analyzed as a single source. Data analytics involves inspecting, analyzing, and modeling data to draw useful conclusions. Digital manufacturing encompasses any system where a physical object is fabricated from a digital model. Such systems include three-dimensional (3D) printers (also known as additive manufacturing), computer numeric control (CNC) machinery, laser cutters, robotic systems, and others.

### SUMMARY OF THE DISCLOSURE

This specification describes technologies relating to data aggregation and analytics for digital manufacturing. Specifically, this specification describes techniques to collect, transmit, store, process, and visualize data used with digital manufacturing systems. In general, one innovative aspect of the subject matter described herein can be embodied in methods that enable process data from multiple digital manufacturing machines, such as error state, material consumption, or job scheduling, to be aggregated and visualized in real-time.

Particular embodiments of the systems described in this specification can be implemented to realize one or more of the following advantages. Detailed, real-time and historical data from a digital manufacturing system can be used to improve production efficiency and plan for future changes. However, digital manufacturing systems communicate and log data in numerous disparate protocols without standard application programming interfaces (API) to report events. The use of data aggregation and analytics across digital manufacturing systems enables data to be consolidated and accessible to all workers involved in the digital manufacturing process. Analysis and visualization of digital manufacturing data enables insights that aid increases in automation, efficiency, and machine utilization.

In some embodiments, a system for aggregating and analyzing data for digital manufacturing data includes a number of digital manufacturing machines that each includes a measurement tool and a processor for generating output data measured by the at least one measurement tool. An aggregator receives and filters the output data and sends the filtered output data to a server. The server stores the output data in a standardized format for retrieval by clients. The client can query the server for desired output data using an application programming interface (“API”).

In some embodiments, a method for aggregating an analyzing digital manufacturing data is provided. The method includes receiving, at an aggregator, output data from a plurality of digital manufacturing machines, combining and filtering the output data at the aggregator, and sending the combined and filtered data to a server for storage in a database. A client device can query the server for desired data using an API.

The details of one or more implementations are set forth in the accompanying drawings and the description below. Other features and advantages will be apparent from the description and drawings.

### BRIEF DESCRIPTION OF THE DRAWINGS

For a fuller understanding of the inventive embodiments, reference is made to the following description taken in connection with the accompanying drawings in which:

FIG. 1. illustrates an example system configuration, in accordance with various embodiments;

FIG. 2. illustrates an example system for data aggregation from a connected machine, in accordance with various embodiments;

FIG. 3. illustrates an example system for data storage, retrieval, and communication with a connected client, in accordance with various embodiments;

FIG. 4. illustrates an example client interface with visualizations for data analytics, in accordance with various embodiments; and

FIG. 5 shows a flowchart of a method for aggregating and analyzing digital manufacturing data.

### DETAILED DESCRIPTION OF THE PREFERRED EMBODIMENTS

Described herein are implementations of data aggregation and analytics for use with digital manufacturing. Digital manufacturing generates large quantities of data for machine input (e.g. 3D model geometry and toolpath/machine instructions) and machine output (e.g. sensor readings, process state, error descriptions). The wide variety of input geometry used with digital manufacturing means that analyzing machine output data can vastly improve the understanding of system performance. As described below, data aggregation and analytics may be used to provide accessible real-time and historical data that can inform decision-making and improve manufacturing efficiency and planning

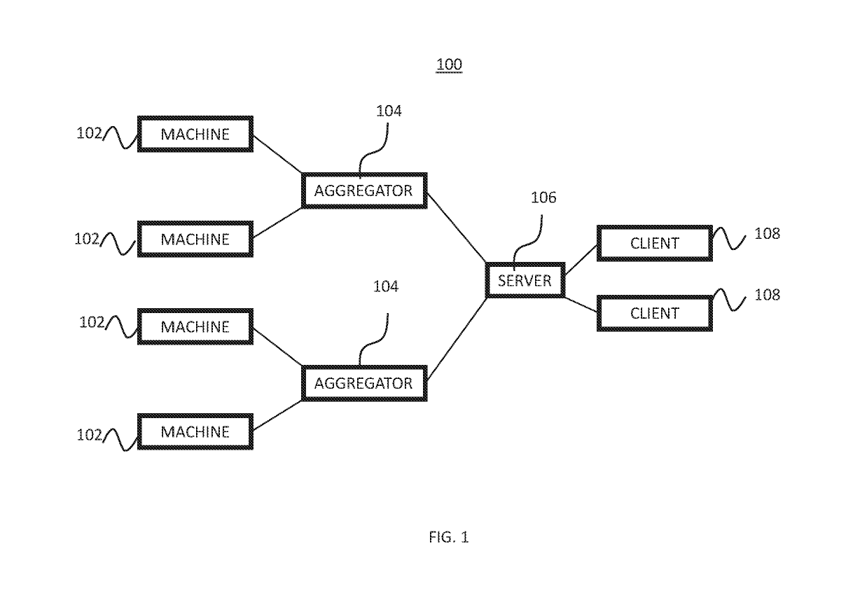

FIG. 1 shows a schematic view of system 100 for aggregating and analyzing digital manufacturing data, in accordance with various embodiments. System 100 include a number of machines 102, aggregators, 104, servers 106, and clients 108. Generally speaking, a system that operates in accordance with the principles disclosed herein can include any number of the aforementioned nodes as the concepts are scalable for use with small scale digital manufacturing concerns to large scale complex operations. Each device of system 100 may include one or more of a processor and/or control circuitry (e.g. a microprocessor or ASIC), a memory, communications circuitry (e.g. a network interface card or other wired or wireless network interface component), a power supply, an input component (e.g. a keyboard, mouse, and/or a touchscreen display), a display assembly, and a bus that provides a data transfer path for transferring data and/or power between the various components of the device.

Machines 102 are all, or a subset of all, of the electronic tools used to manufacture a product using a digital manufacturing process. Non-limiting examples of machines 102 include: 3D printers, including vat photopolymerisation tools, material getting tools, binder jetting tools, material extruders, powder bed fusion tools, sheet laminators, and directed energy deposition tools; CNC machinery; laser cutters; other robotic systems capable of altering or measuring the physical attributes of a digitally manufactured product. The number of machines used in a particular digital manufacturing process depends generally on the complexity of the product being manufactured. For example, a particular product may require different tools for additive processing (e.g. one or more 3D printers), one or more tools for subtractive processing (e.g. a CNC machine or laser cutter), and one more tools for finish processing (e.g. a grinder or polisher.

Machines 102 receive data using the communications circuitry and/or input component. Data received at machines 102 can include, for example, one or more CAD files that describe the geometry of the product to be manufactured and/or processing parameters that describe how the tool should operate (e.g. material type, material color, operating temperature, and deposition times and rates). Received data may also include expected values for measurements a particular tool is configured to make during or after completion of its task.

This input data, received at machines 102 directly (e.g. utilizing an I/O device such as a keyboard) or via other network connected devices within system 100, may be compared to data output by machines 102. For example, a 3D printer equipped with one or more measurement apparatus that monitor operating conditions and results of the printing process (e.g. a thermometer for monitoring one or more operating temperatures, a laser interferometer for measuring the dimensions of the digitally manufactured product) can compare the measured data to one or more defined or otherwise expected values to ensure, in real-time, that the tool is operating as expected. In the event that data measured on a particular machine falls outside of a range given the input data, the machine may raise an alarm or write the error to a log file stored in memory.

Machines 102 also transmit output data to other devices of system 100 using the communications circuitry. In particular, machines 102 can transmit the measurement data discussed directly above and/or data regarding machine events such as errors, user interventions, or machine status. Transmitting output data to another device within a digital manufacturing system can advantageously promote efficiencies in the manufacturing process.

For example, if the output data for each machine in system 100 is available on a single device (e.g. one or more clients 108, as described in detail below), the task of monitoring the manufacturing process for errors, excursions, and other tooling-related problems is streamlined considerably. Rather than requiring humans to manually monitor the output data for each of machines 102, a task that traditionally would require a person to interact directly with each machine (a monumental task for complicated digital manufacturing operations that might use 10 s, 100 s, or 1000 s of tools), output data from machines 102 can be aggregated and made available for analysis on a single device. Thus, a person tasked with monitoring a manufacturing process undertaken by system 100 may be presented with a wealth of real-time and historical data at a single device. An alarm set by one machine might, therefore, be sent to one or more remote terminals (e.g. clients 108) at which a decision may be made to take the machine offline for servicing, adjust its operating parameters in real time, or even just to ignore the alarm.

Aggregators 104 perform the task of aggregating output data from machines 102. In some embodiments, aggregators 104 receive raw data from machines 102, in the form of log files or network packets, for example. As depicted in FIG. 1, a digital manufacturing system might include several aggregators 104, each in communication with one or more machines 102. A typical usage scenario is inside of a company or institution with multiple machines. Data aggregation is performed for each machine as shown in FIG. 1. A given data aggregator is capable of working with one or more machines. The process of data aggregation can be performed in a number of ways by reading available data sources and forwarding relevant data on to a server. The following is a list of example data sources that can be used: log files saved on the system can be watched, read, and parsed to extract real-time data on machine events such as errors, user intervention, or machine status; network packets travelling between the machine and aggregator can be monitored to extract machine events as they happen—this monitoring may be passive listening, or active requests send to the machine to poll the latest data; machine or database API access allows a direct route to query machine status; and asset files, such as geometry files or machine instruction files can be analyzed to provide additional data including layout, size, and resolution.

In some embodiments, a single aggregator might collect data from all machines in a given digital manufacturing system. In other embodiments, multiple aggregators can be provided to collect and aggregate data from among machines 102. Provision of multiple aggregators for a digital manufacturing system might be useful in a number of circumstances. For example, if machines 102 in system 100 are located in geographically diverse locations, such as in the case of sister digital manufacturing plants, an aggregator might be provided for collect output data from the machines physically located in each location. As another example, one or more specialized aggregators might be provided to collect output data from similar types of machines, such as machines that output the same or substantially the same types of output data in the same or substantially the same format in order to ease the task of aggregating, filtering, and organizing the data. As yet another example, multiple aggregators may be provided for reasons of redundancy, data storage considerations, and/or advantages stemming from parallel processing of large quantities of output data.

Aggregators 104 may also perform the service of filtering or otherwise processing the output data received from machines 104. For example, machines 102 often provide a considerable amount of data that is not germane to tool operation, such as system check and/or debug data. Tools may also generate output data with empty data fields, as may be the case for tool measurements that are possible but either not enabled or not possible (e.g. cases in which tool is not physically equipped with the necessary measurement component). Other output data might represent bogus data—that is, mismeasurements of one type or another that fail to faithfully report true measured values. Aggregators 104 can delete or otherwise filter out these types of data output data before transmitting the data on to other devices within system 100.

Once aggregators 104 collect and process output data received from machines 102, the data may be sent to servers 106. It should be appreciated that the transmittal of data between machines 102, aggregators, 104, and servers 106 may occur continuously and in real time and/or on a batched basis. For example, machines 102 might transmit measurement data in the form of a continuous stream of network packets or as batched data in the form of a log file to aggregators 104. In turn, aggregators 104 can send data received from machines 102 immediately after processing, periodically, or after a threshold amount of data has been aggregated. Aggregators 104 may also cache data in case of a communication or network failure for later transmission.

Servers 106 are responsible processing and storing output data such that it is accessible to clients 108 via an application programming interface (“API”). In some embodiments, servers 106 can be equipped with persistent storage that hosts one or more databases. This database(s) can, in turn, store output data in a standardized format for retrieval by clients 108. In some embodiments, input data, such as expected values or value ranges for the output data or other relevant metadata, such as machine location or service and repair records, may also be stored in the database(s).

Data received from one or more aggregators 104 is received at the server for processing and storage. Incoming data includes information about the source of the data (e.g. an API key), so that it can be correctly assigned to the appropriate account; the make, model, and serial number of the machine; start and end times for a particular machine event; and data associated with a machine event. API keys are particularly important in the event where servers 106 are cloud-based devices that receive data from aggregators associated with many disparate entities (e.g. multiple companies, universities, research institutions, or individuals). As data is received, it can be segmented down to the level of a machine event, which is the most granular level of a machine communication protocol.

When received, the data associated with the machine events are stored in the database for further processing. As they are entered into the database, another process collates the events into a job structure that is updated as events pertaining to that job are received. Information stored in the jobs structure includes properties such as machine state, material usage, errors, and time of execution. A job is completed either when there is an error or the process has completed. The job structure provides detailed information about machine usage and performance and is the basis for computing business metrics from low-level data.

Business metrics include measures of machine information over a wide time span and require large quantities of information to be processed. The amount of data processed for a given request can be reduced if even just a portion of the relevant information has been previously processed by using a memoization caching mechanism. Memoization matches the inputs to a computation with the result. If further computations have identical arguments, the entire computation can be skipped and the previously calculated results returned with very little overhead. However, for each unique computation, the results have to be stored. To avoid excess storage use, memoized computations typically expire after a given amount of time or if storage usage has exceeded a particular threshold.

For ordered information whose aggregating operations are associative, memoization can also be used to determine partial results. For example, it may be useful to determine material usage over a given time period for a machine, such as a 3D printer. The material usage data in all jobs for the printer over the given time period can be accumulated into a histogram summing the amounts of each material used. If a second similar query is processed containing the already processed time period, the memoization of that original computation can be used along with the relevant data from the remaining time periods.

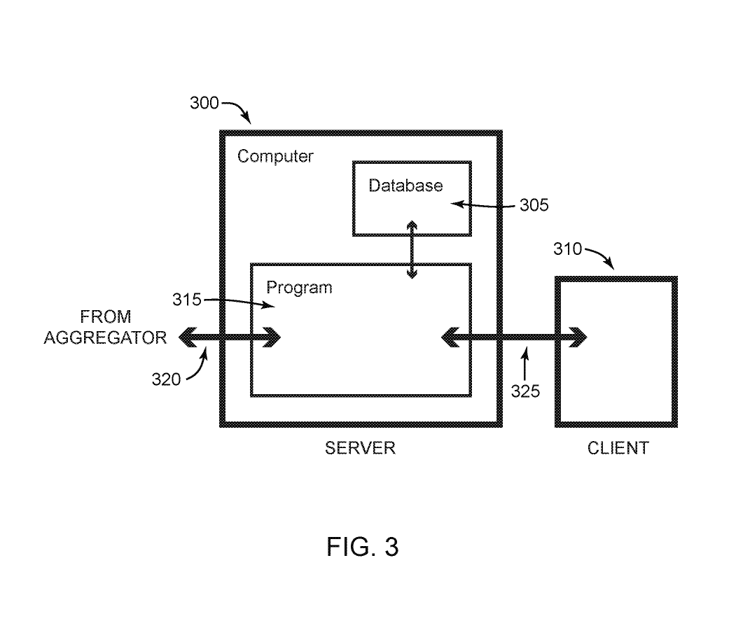

Clients 108 query servers 106 for data using the API. An exemplary API for communicating data between servers 106 and clients 108 is provided below in the discussion concerning FIG. 3. The data returned to clients 108 may then be presented to a user for the purpose of analytics.

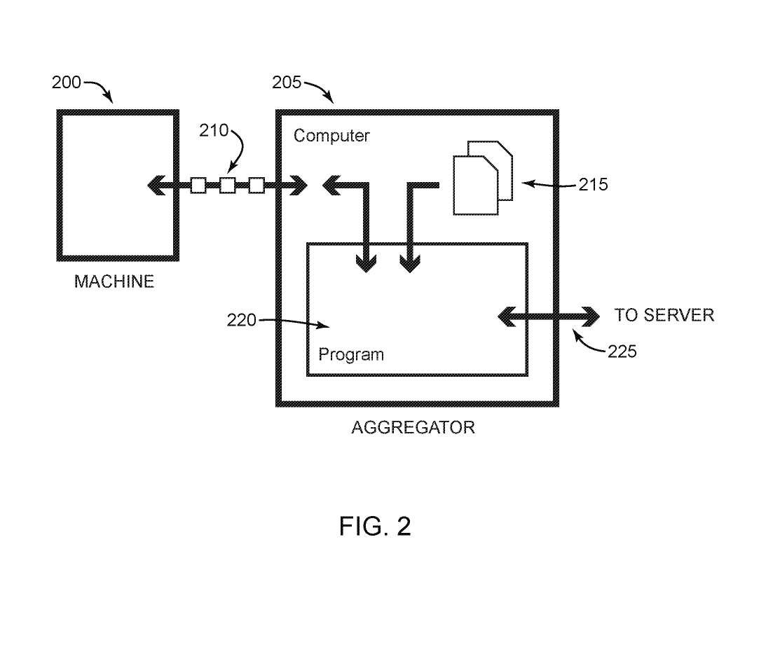

FIG. 2 shows a schematic view of a system for aggregating and analyzing digital manufacturing data, in accordance with various embodiments. In particular, FIG. 2 a more detailed view of the machine and aggregator components system 100 of FIG. 1. The system includes software program 220 installed on aggregator 205, which is communicatively coupled to machine 200 directly or through a network. Software program 220 listens to packets 210 sent from the machine 200 and reads log files 215 received from machine 200 for relevant data. In some embodiments, log files 215 are mounted over the network. As described above, aggregator 205 can filter and/or process the output data received from machine 200 may before sending it on to the server.

FIG. 3 illustrates an example embodiment of a data server used for aggregation and analytics. Data from an aggregator 320 is received by a software program 315 running on a network connected computer 300. The data may be filtered, parsed, or processed before being stored in a database 305. When an API call is received from the client 310 the program 315 queries the database 305 for the appropriate data, then performs processing if necessary, before transmitting the response 325 back to the client 310. API functionality offers both low-level details about jobs and events, as well as high level statistics. For example, the API may provide a routine for returning a list of jobs such as below.

API Query: get_completed_jobs?api_key=12345&max_jobs=1
API Response:
{

“status”: {

“code”: “ok”

},
“data”: [

{

“name”: “Job12345”,
“id”: “0660c945ee”,
“owner”: “PC-2220”,
“completed”: true,
“time”: {

“start”: “2015-01-12T19:34:37.000Z”,
“duration_stimate”: 12910,
“end”: “2015-01-12T23:11:08.000Z”,
“duration”: 12991

},
“machine”: {

“make”: “Acme”,
“model”: “Fortrus”

},
“materials”: [
{

“material”: “material01”,
“start_amount”: 820,
“end_amount”: 680,
“consumption_estimate”: 124.7,
“consumption”: 140.1

},
{

“material”: “material02”,
“start_mount”: 4720,
“end_amount”: 4520,
“consumption_estimate”: 145.4,
“consumption”: 200.1

}

],

“geometry”: [

“geometry_final_01”,
“geometry_final_02”,
“geometry_final_03”

]

}
]

}

The API can be made available publicly to enable integration with other software systems. In the above example, the API key determines the functionality that is available to the API caller. The API key is checked against an internal database to log usage and set API access permissions.

On a client computer an interface is provided for data analytics and visualization. The preferred embodiment of the client interface is a browser-based web application. The client uses an API to query the server, then processes the received data into an appropriate format for visualization.

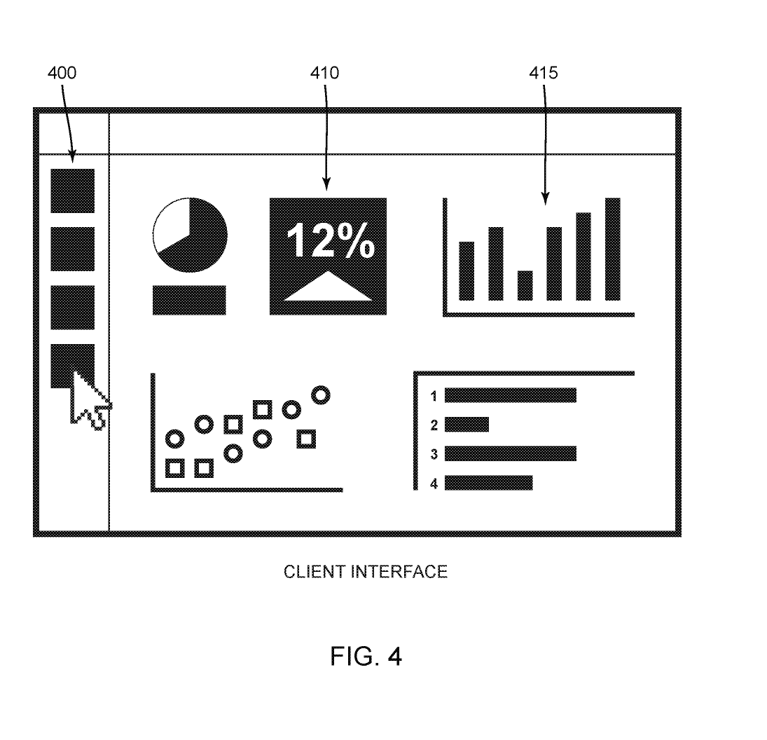

FIG. 4 shows one example embodiment of a client interface. Navigation elements 400 are used to change content such as textual 410 and graphical 415 charts and illustrations. Content can be grouped according to categories such as machines, materials, geometry, time range, error events, and user events. The client interface may be customizable so that users can specify the exact data they want visualized. An interface can be provided that allows users to choose different options for data sources, visualization formats, and layout. The client interface may provide a scripting or plugin feature to allow programmatic control over how data is visualized.

The client interface typically provides access to aggregated data from all machines under a given account. However in some scenarios it may be useful to compare data between accounts to understand machine performance. For example, comparing the number of errors generated from a given machine with the average number of errors generated by similar machines, may indicate the machine is due for servicing. In these scenarios data from other accounts may be presented in an anonymized format.

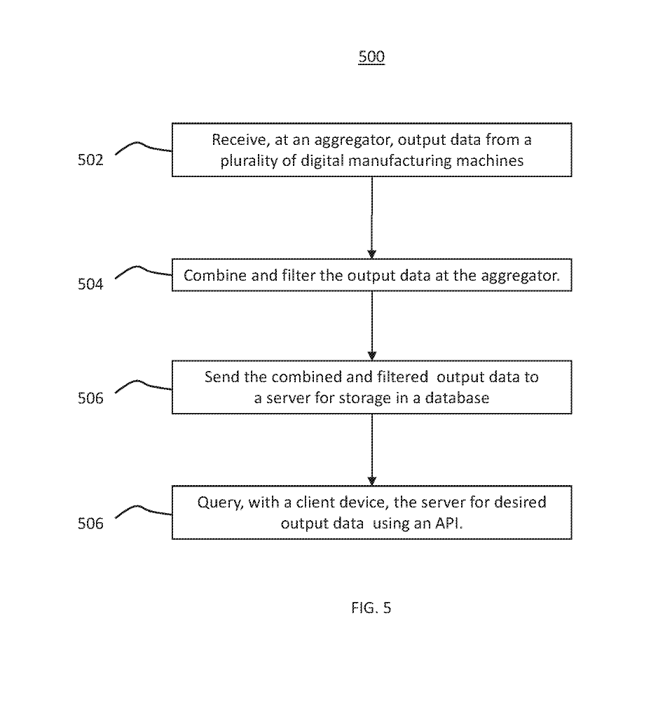

FIG. 5 depicts a flowchart of a method 500 for aggregating and analyzing digital manufacturing data, in accordance with some embodiments. At step 502, an aggregator receives output data from a plurality of digital manufacturing machines. The data may be received at communications circuitry, such as a network interface card (NIC) or other wired or wireless. These digital manufacturing machines (e.g. machines 102 of FIG. 1) may be used to manufacture a product using a digital manufacturing process. Generally speaking, the machines can fall into one of four categories, additive tools, subtractive tools, finishing tools, and measuring tools. Each machine is configured to receive input data that contain instructions regarding how to process the product. Each machine also generates output data that can include, for example, physical measurement data of the product, attributes of the machine itself, and/or information describing the machine.

At step 504, the aggregator combines and filters the output data received from the digital manufacturing machines. Combining the output data can include receiving data from a number of different digital manufacturing machines, and filtering out unnecessary data, and concatenating the filtered output data for transmission to a server. At step 506, the filtered output data is sent to the server for storage in a database.

At step 508, a client device queries the server for data stored thereon. For example, the client device can request, via an API stored thereon, historical data for a particular machine, real-time data for all running machines, and any combination of the above.

The systems described herein, or portions thereof, can be implemented as a computer program product or service that includes instructions that are stored on one or more nontransitory machine-readable storage media, and that are executable on one or more processing devices to perform or control the operations described herein. The systems described herein, or portions thereof, can be implemented as an apparatus, method, or electronic system that can include one or more processing devices, parallel processing devices, and memory to store executable instructions to implement various operations.

It should be understood that the aspects, features and advantages made apparent from the foregoing are efficiently attained and, since certain changes may be made in the disclosed inventive embodiments without departing from the spirit and scope of the invention, it is intended that all matter contained herein shall be interpreted as illustrative and not in a limiting sense.

What is claimed is:

1. A system for aggregating and analyzing data for digital manufacturing data, the system comprising:
a plurality of digital manufacturing machines, each digital manufacturing machine comprising at least one measurement tool and a processor for generating output data measured by the at least one measurement tool;
at least one aggregator communicatively coupled to the plurality of digital manufacturing machines, the aggregator comprising a memory comprising instructions stored thereon for receiving and filtering the output data; and
at least one server communicatively coupled to the at least one aggregator, the at least one server comprising a database that stores the output data in a standardized format for retrieval by clients.

2. The system of claim 1, further comprising:
at least one client device communicatively coupled to the at least one server, the at least one client device comprising memory having instructions stored thereon for querying the database for data stored therein.

3. The system of claim 2, wherein the instructions for querying the database for data comprise an application programming interface (“API”) that establishes a protocol for communication and data retrieval between the client and the database.

4. The system of claim 1, wherein the plurality of digital manufacturing machines comprise at least one additive tool.

5. The system of claim 4, wherein the at least one additive tools is a 3D printer.

6. A method for aggregating an analyzing digital manufacturing data, the method comprising:
receiving, at an aggregator, output data from a plurality of digital manufacturing machines;
combining and filtering the output data at the aggregator; and
sending the combined and filtered data to a server for storage in a database.

7. The method of claim 6, further comprising:
querying the server, with a client device, for desired data using an API.

8. The method of claim 6, further comprising storing input data on the server.
